(19) United States
(12) Patent Application Publication
(10) Pub. No.: US 2011/0122026 A1
(43) Pub. Date: May 26, 2011

(54) Scalable and/or reconfigurable beamformer systems

(76) Inventors: Matthew P. DeLaquil, Rockwall, TX (US); Charles E. Baucom, Greenville, TX (US); Deepak Prasanna, Rockwall, TX (US)

(21) Appl. No.: 12/592,426

(22) Filed: Nov. 24, 2009

(51) Int. Cl. H01Q 3/00

(52) U.S. Cl. 342/372

(57) ABSTRACT

A scalable and/or reconfigurable true-time-delay analog beamformer system having a hierarchical distributed control architecture composed of an arbitrary number of reconfigurable and scalable units. The beamformer system may be applied to an antenna array with an arbitrary number of elements in a scalable manner and the configuration of the beamformer system may be implemented so that it is capable of reconfiguration by changing its beam-position mapping, either dynamically or at install-time. The number of beams or beam positions that are desired advantageously do not need to be known prior to the design or selection of the beamformer system.

### FIELD OF THE INVENTION

This invention relates generally to beamforming, and more particularly to beamformer systems.

### BACKGROUND OF THE INVENTION

Beamforming takes advantage of interference to change the directionality of an antenna array. When transmitting, a beamformer controls the phase and relative amplitude of the signal at each transmitter, in order to create a pattern of constructive and destructive interference in the wave front. When receiving, information from different sensors is combined in such a way that the expected pattern of radiation is preferentially observed.

With narrow band systems the time delay is equivalent to a “phase shift”, and an antenna array including multiple elements that are each shifted a slightly different amount, is called a phased array. Phased array apparatus are employed in a variety of applications for transmitting and receiving radar and other types of radio-frequency (RF) signals, and may be implemented in a variety of geometric array configurations. Examples of array configurations include linear arrays, two-dimensional arrays, planar arrays, rectangular arrays and conformal arrays.

Phased arrays include multiple antenna elements coupled with analog phase shifters that allow electromagnetic energy to be sent and received along desired wave front directions. Phase shifters associated with the various elements allow the beam shape and directivity of the array to be varied. By using phase shifting devices to alter the phase of signals transmitted or received by individual phased array elements relative to each other the directional orientation of signals transmitted or received by the array may be controlled. Examples of phase shifting devices include digital phase shifting devices (e.g., diode phase shifter using switched-line, hybrid-coupled and loaded-line) and analog phase shifting devices that are digitally controlled (e.g., ferrite phase shifter). The directivity and other desirable characteristics of the array, such as low side lobe energy, can be further improved by properly controlling the amplitude response of the various elements.

Phase control allows the phase shifters associated with the elements, to aim or steer the array beam pattern in a desired direction. The amount of phase shift necessary to form a desired beam shape can be determined mathematically. Continuous control of each phase shifter over its phase shifting range may be used to provide precise control over the beam shape and directivity. However, phase shifters may also be controlled in discrete steps of phase shift.

### SUMMARY OF THE INVENTION

Disclosed herein are systems and methods that may be employed to implement a hierarchical distributed control architecture to provide a scalable and/or reconfigurable true-time-delay analog beamformer system composed of an arbitrary number of reconfigurable and scalable units. Using the disclosed systems and methods, a scalable reconfigurable beamformer system may be implemented with a wide variety of antenna array configurations, and may advantageously be applied to an antenna array with an arbitrary number of elements in a scalable manner, i.e., the number of antenna elements in a given antenna array does not need to be known prior to the design or selection of the beamformer system. Further advantageously, the configuration of the disclosed beamformer system may be implemented so that it is capable of reconfiguration by changing its beam-position mapping, either dynamically or at installation time. In this regard, the number of beams or beam positions that are desired advantageously do not need to be known prior to the design or selection of the beamformer system. In one exemplary embodiment, the disclosed beamformer systems may be implemented to allow an antenna array to form and steer a narrow beam with low sidelobes over a broad bandwidth using true time-delay elements and amplitude tapering.

In one exemplary embodiment, a beamformer system may be implemented using a single common master controller with multiple unit-level mixed-signal circuit boards or other type of modular unit (e.g., with one modular unit provided per antenna element in the array). Microwave components on each unit level modular unit (e.g., circuit board) remote to the master controller may each be provided as a controller to implement the time-delay and amplitude-tapering required for low-sidelobe beamforming, while digital control components may be used to provide communication with the master controller of the beamformer system. The master controller may be employed for host interface and implementing dynamic reconfiguration capability.

Advantageously, by distributing unit-level control capability the operation of the beamformer system becomes independent of the number of antenna elements in a given array. Furthermore, hierarchical control communication between the master controller and the unit-level boards may be accomplished through a control bus (e.g., such as an addressable serial bus) for scalability purposes, so the number of physical wires that are required to connect the beamformer equipment may be kept at minimum while also being independent of the number of antenna elements used in a given array. Thus, the same beamformer system equipment may be used for a given small antenna array having a relatively small number of antenna elements as for a large antenna array having a relatively larger number of antenna elements, as long as each additional antenna element of a given antenna array is provided with a unit-level beamformer module (e.g., circuit board).

In a further exemplary embodiment, beamformer system configuration information (e.g., such as the number of beam positions, the particular setting values of time-delay and amplitude taper desired for each beam position, the number of array elements that participate in the formation of each beam, etc.) may be stored in non-volatile memory (e.g., such as EEPROM) provided on each of the unit-level digital control components. This beamformer system configuration information may be changed dynamically by the master-controller via communication with the unit-level controllers, and/or alternatively may be manually reconfigured by physically swapping unit-level control chips out of integrated circuit sockets provided on the mixed-signal circuit boards or other type of modular units employed. In this regard, socket-insertable or otherwise replaceable unit-level integrated control chips may be provided to facilitate manual reconfiguration by allowing a first integrated circuit control chip having first beamformer system configuration information thereon to be replaced with a second and different integrated circuit control chip having second beamformer system configuration information thereon.

In one respect, disclosed herein is a scalable analog beamforming system, including: a plurality of time delay unit (TDU) modules, each of the TDU modules including TDU controller circuitry and each given one of the TDU modules being configured for coupling to at least one different array element of a phased array apparatus to receive and change at least one of the phase, amplitude, or combination of phase and amplitude of a signal received from or transmitted to the array element by the given TDU module under the control of the TDU controller circuitry; and master control circuitry coupled to control the TDU controller circuitry of each of the TDU modules, the master control circuitry being configured to digitally control the TDU controller circuitry of each of the TDU modules to change the phase of a signal received from or transmitted to the array element.

In another respect, disclosed herein is a method for operating an analog beamforming system, including: providing a plurality of time delay unit (TDU) modules of a beamforming system, each of the TDU modules including TDU controller circuitry and each given one of the TDU modules being coupled to at least one different array element of a phased array apparatus; and digitally controlling the TDU controller circuitry of each given one of the TDU modules to change at least one of the phase, amplitude, or combination of phase and amplitude of a signal received from or transmitted to the array element by the given TDU module.

In another respect, disclosed herein is a phased array apparatus, including: a plurality of array elements; a plurality of time delay unit (TDU) modules, each of the TDU modules including TDU controller circuitry and each given one of the TDU modules being coupled to at least one different array element to receive and change the phase of a signal received from or transmitted to the array element by the given TDU module under the control of the TDU controller circuitry; and master control circuitry coupled to the TDU controller circuitry of each of the TDU modules, the master control circuitry being configured to digitally control the TDU controller circuitry of each of the TDU modules to change the phase of a signal received from or transmitted to the array element.

### BRIEF DESCRIPTION OF THE DRAWINGS

FIG. 1 is a block diagram of a phased array antenna system according to one embodiment of the disclosed systems and methods.

FIG. 2 is a block diagram of a phased array antenna system according to one embodiment of the disclosed systems and methods.

FIG. 3 is a block diagram of a beamformer system 101 according to one embodiment of the disclosed systems and methods.

FIG. 4 is a block diagram of a time delay unit (TDU) according to one embodiment of the disclosed systems and methods.

FIG. 5 illustrates logical control flow according to one exemplary embodiment of the disclosed systems and methods.

### DESCRIPTION OF ILLUSTRATIVE EMBODIMENTS

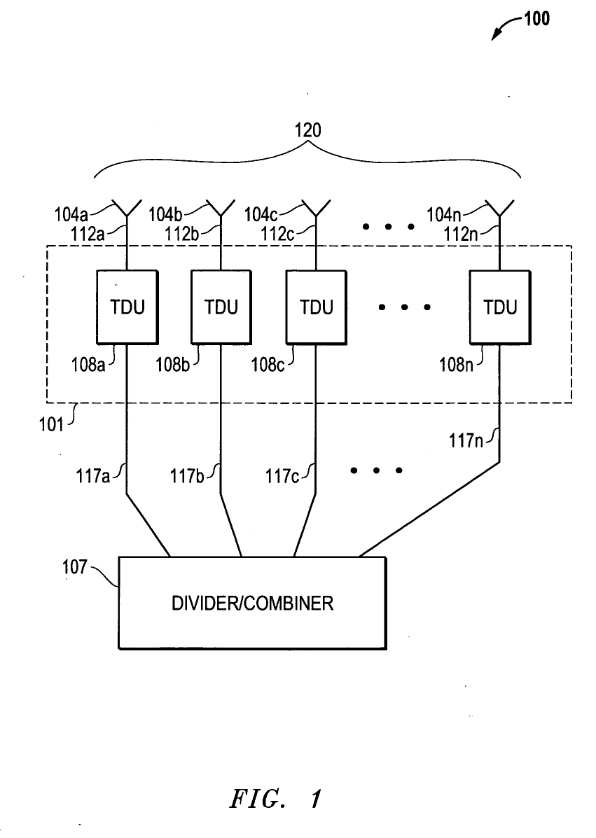

FIG. 1 is a simplified block diagram of a phased array antenna system 100 according to one embodiment of the disclosed systems and methods. As illustrated in FIG. 1, antenna system 100 includes an antenna array 120 made up of multiple antenna elements 104a through 104n. As shown, each of multiple antenna elements 104a through 104n is coupled to exchange signals (e.g., radio frequency signals) 112a to 112n with a respective modular time delay unit (TDU) 108a to 108n of a scalable and reconfigurable true time delay analog beamformer system 101. In this regard, the number of antenna elements 104 of a given phased array antenna system 100 may be arbitrary, and the number of modular TDU units 108 may be varied to correspond to the number of antenna elements 104 of a given phased array antenna system 100.

Still referring to FIG. 1, each of TDU units 108a to 108n is in turn coupled to signal divider/combiner 107 that is configured to combine separate output signals 117a to 117n from TDU modules 108a to 108n and corresponding to separate antenna elements 104a through 104n, and/or to divide separate signals 117a to 117n to be provided to TDU modules 108a to 108n and transmitted by separate antenna elements 104a through 104n, as appropriate. In the illustrated embodiment, each TDU 108 may be digitally controlled to independently vary the phase of radiation or other type of signal transmitted or received by the respective element 104 coupled to a corresponding TDU 108, e.g., relative to the phase of signals transmitted or received by other elements 104 of the array 120. By so independently varying the phase, signals are transmitted or received by each element 104 relative to each other element 104, the direction of maximum signal intensity transmitted or received by antenna array 120 may be controlled.

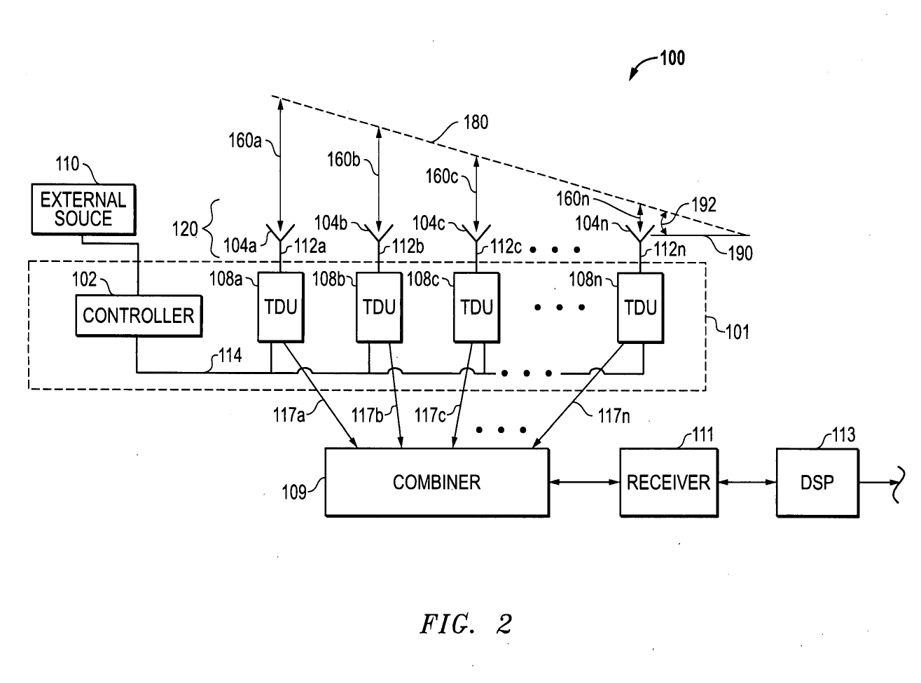

FIG. 2 illustrates one exemplary embodiment of a phased array antenna system 100 having an antenna array 120 made up of multiple antenna elements 104a through 104n as it may be implemented to receive separate signals 112a to 112n of a directional signal wave front 180. Phased array antenna system 100 is illustrated configured as a receive-only system in FIG. 2, with each TDU 108a through 108n being coupled to signal combiner 109 which is in turn coupled to receiver 111 and digital signal processor (DSP) 113.

It will be understood that in alternate embodiments a phase array antenna system 100 may be alternatively configured as a transmit only system (e.g., with divider circuitry coupled between a transmitter and TDU 108a to TDU 108n of scalable reconfigurable beamformer system 101 to divide separate signals 117a to 117n to be transmitted as signals 112a to 112n by separate antenna elements 104a through 104n), or may be alternatively configured as a transmit and receive system (e.g., with receive/transmit switch circuitry and combiner/divider circuitry coupled between a transceiver and TDU 108a to TDU 108n of scalable reconfigurable beamformer system 101 to combine separate signals 117a to 117n received from TDU modules 108a to 108n and to divide separate signals 117a to 117n and provide these signals to TDU modules 108a to 108n for transmission as signals 112a to 112n by separate antenna elements 104a through 104n). In this regard, it will be understood that a scalable reconfigurable beamformer system 101 may be employed to vary the phase of transmitted signals in a manner similar to the process of varying the phase of received signals discussed in relation to the exemplary embodiment FIG. 2, e.g., using suitable low noise amplifier circuitry for receive applications and suitable high power amplifier circuitry for transmit applications.

As illustrated for the exemplary embodiment of FIG. 2, scalable reconfigurable beamformer system 101 includes off-module master control circuitry in the form of a master controller 102 coupled to each of multiple TDU modules 108a to 108n by an addressable control bus 114 (e.g., addressable serial bus) that provides control signals from master controller 102 to each of TDU modules 108a to 108n. In one exemplary embodiment, each of TDU modules 108a to 108n may be implemented as a separate circuit board or other modular form of circuit component with master controller 102 being provided as an off-module (e.g., off-board or otherwise provided separate from modules 108) component that interfaces with an external source 110 (e.g., human or machine interface host). External source 110 may be coupled to communicate with master controller 102 of beamformer system 101. In the illustrated embodiment, control bus 114 provides control signals from master controller 102 to each of TDU modules 108a to 108n. In this manner, each TDU 108 may be digitally controlled to independently vary the phase of radiation or other type of signal received by the respective element 102 relative to the phase of signals received by other elements 102 of the array 120. Control signals may be further provided by master controller 102 to optionally control the amplitude (by applied gain or attenuation) of each TDU 108 relative to the amplitude of each other TDU 108 to further control the pattern of signals received by antenna array 120. For example, in one exemplary embodiment when using an addressable serial bus, 11 delay bits and 6 amplitude bits may be provided by master controller 102 to each TDU 108 for control of signal delay and amplitude, and additional signal lines are not required for control of new TDU modules 108 as more are added to the beamformer system 100.

FIG. 2 shows radiation or signal wave front 180 being received by antenna array 120 and having a longitudinal axis that is oriented at an angle with respect to the longitudinal axis 190 of antenna array 120. In the illustrated embodiment, the angle of orientation 192 of signal wave front 180 with antenna array 120 is controlled by individual signal delay times 160a through 160n that are imparted by TDU modules 108a to 108n in response to digital control signals provided by master controller 102. In this regard, the magnitude of individual signal delay times 160a through 160n may be cooperatively increased so as to increase magnitude of angle 192, or may be cooperatively decreased to decrease the magnitude of angle 192. When the magnitude of individual signal delay times 160a through 160n are set to be equal, the wave front angle 180 is 0° and energy wave front 180 is oriented parallel to the longitudinal axis 190 of antenna array 120. Further information on operation of phased array antenna systems may be found U.S. Pat. No. 7,205,937 which is incorporated herein by reference in its entirety. It will also be understood that using the disclosed systems and methods, master controller 102 may be provide digital control signals to “split” antenna array 120, i.e., such that opposite ends of the antenna array 102 point in different directions.

It will be understood with benefit of this disclosure that FIGS. 1 and 2 illustrate only exemplary embodiments of phased array antenna systems as they may be implemented in the practice of the disclosed systems and methods. In this regard, the number and geometrical configuration of antenna elements, and/or the configuration and identity of processing circuit components coupled thereto, may be selected and varied as needed or desired to achieve the desired signal receiving and/or transmitting characteristics of a given antenna system application. For example, the specific configuration of antenna elements, TDUs, divider, combiner, transceiver and/or digital signal processor (“DSP”) may be changed, and/or the number and types of components changed (e.g., no DSP present; transceiver or transmitter substituted for receiver; combiner/divider or divider substituted for combiner; individual transceiver, receiver or transmitter directly coupled to each TDU without presence of an intervening combiner/divider, combiner or transmitter; etc.). Furthermore, an antenna array may be of any geometrical configuration suitable for implementation as a phased array including, for example, linear array, two and three-dimensional array, planar array, rectangular array, conformal array, etc.

Additionally, master controller 102 may be coupled to control TDUs 108 using any suitable technology other than a control bus, for example, using a wireless control medium, non-bus wired communication medium (e.g., star topology with master controller 102 in star center coupled to peripheral TDUs 108), etc. Moreover, master control circuitry may be implemented to control TDU modules 108 in suitable manner using one or more processing devices and/or using separate control circuitry entities. For example, master control circuitry may include two or more master controllers 102 that each interface with external source 110 (e.g., two master controllers 102 that each control half of the TDU modules 108, four master controllers 102 that each control one quarter of the TDU modules, etc.). Thus, master control circuitry may be implemented in one exemplary embodiment as a master controller 102 that acts as a common control source for two or more TDU modules 108, and two or more such master controllers 102 may be present. In yet another embodiment, a separate master controller 102 may be provided to control an individual TDU module 108, e.g., such as a wireless implementation where each TDU module 108 has its own separate master controller 102 that in turn communicates wirelessly with an external source 110, e.g., a host device.

In addition, a group of multiple antenna elements 104 may be coupled to a single TDU 108, and an antenna array 120 may be thus formed from individual groups of antenna elements 104 (i.e., rather than formed from single antenna elements 104). In such an implementation, the phase of signals transmitted or received by a given group of antenna elements may be independently varied by its respective phase shifting device relative to the phase of signals transmitted or received by other groups of antenna elements to achieve directional control over the received or transmitted signals.

Furthermore, it will be understood that the disclosed systems and methods may be implemented with any other type of phased array antenna system, with any other type of antenna system having multiple antenna elements, or with any other type of apparatus or system employed to phase shift a signal or to phase shift multiple signals relative to each other (e.g., apparatus or system having multiple phased array elements). In this regard, the disclosed systems and methods may be implemented with any apparatus configured to receive and/or transmit signals of any frequency or frequency range suitable for propagation through a variety of media including, but not limited to, gaseous medium (e.g., air), solid medium (e.g., earth, tissue), vacuum, etc. Examples of types of apparatus and systems that may be implemented with the disclosed systems and methods include, but are not limited to, phased array radio frequency (RF) antennas or beamformers, sonar arrays (for transmitting/receiving acoustic signals), ultrasonic arrays (ultrasonic signals for medical and flaw analysis imaging purposes), radar arrays (e.g., for bi-static and mono-static radar), mobile and land based telecommunications devices, seismic arrays, etc. Examples of specific types of phased array RF antennas that may be implemented with the disclosed systems and methods include, but are not limited to, narrow band phased array antennas, broad band phased array antennas, etc. In one embodiment, the disclosed systems and methods may be implemented at any RF frequencies where phased array antennas may be employed (e.g., HF band, KA band, M band, etc.) In another exemplary embodiment, the disclosed systems and methods may be employed in surveillance applications (e.g., airborne, ship-based, space-based, submarine based, etc.) including, but not limited to, as a part of a tactical reconnaissance system.

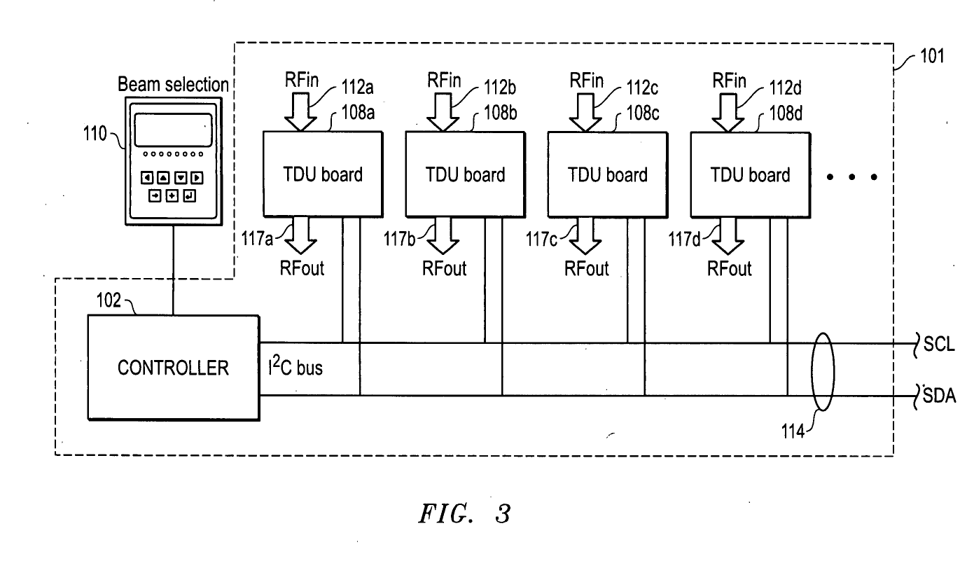

FIG. 3 is a board level depiction of one exemplary embodiment of beamformer system 101 as it may be configured for receiving RF signals. In this embodiment, a beam position selection may be made utilizing an external source 110 that may be, for example, a human user interface such as a notebook or laptop computer, keypad, smart phone, specialized handheld controller, etc. As shown in FIG. 3, individual signals 112 are received from antenna element 104 at TDU modules 108. As previously described, communication between master controller 102 and each TDU 108 is made by utilizing an addressable control bus 114, in this embodiment an addressable serial inter-integrated circuit (I²C) bus including serial data (SDA) and serial clock (SCL) lines, e.g., such as a 2-line addressable 0 to 3.3 volt 400 kHz serial bus or other suitable control bus. Addressable I²C bus serial communication protocol may be transmitted, for example, using two wires of a four-wire cable to which connections to each additional TDU module may be simply made using a clamp-on insulation-displacement connector (IDC) or other suitable type of clamp-on connector. The other two wires of the four-wire cable may be employed for ground and reset. However, any other suitable cabling and interconnection methodology may be employed. Other examples of suitable serial communication protocols that may be employed include, but are not limited to, serial peripheral interface (SPI) bus.

In this exemplary embodiment, use of a serial communication link between master controller 102 and respective controller circuitry of TDU modules 108 enhances the scalability of beamformer system 101 by eliminating the need for additional lines required by a parallel communication link. Use of an addressable serial link also enhances the reconfigurability of the beamformer system 101 by enabling targeted communication with individual TDU modules 108 and dynamic reprogramming of lookup tables that store the mapping of beam position to delay and attenuation settings. However, it will be understood that any other signal bus suitable for individually controlling operation of each TDU 108 in the manner described herein may be employed including, for example, a parallel communication link or a non-addressable serial communication link. In any case, dynamic real time control of each TDU 108 may alternatively be performed in a further embodiment without the use of lookup tables stored in memory of the individual TDU modules 108, e.g., by using transmitting real time control signals including delay setting value and/or attenuation setting value to each TDU 108 of beamformer system 101 to directly control delay and/or amplitude tapering to achieve the desired beam position. Alternatively, where lookup tables are employed and stored in memory of each TDU module 108, master controller 102 may generally broadcast a non-addressed beam position command to all TDU modules 108 (e.g., across a non-addressable control bus), each of which may respond by looking up delay and amplitude settings for the given TDU 108 that correspond to the broadcast beam position.

Master controller 102 may be, for example, a RCM3700 RabbitCore® 10Base-T Ethernet microprocessor-based core module with Ethernet, I/O and onboard mass storage capability that is available from Rabbit Semiconductor Inc. of Davis, Calif., or other suitable processing device (e.g., microprocessor, processor, field programmable gate array, application specific integrated circuit, etc.).

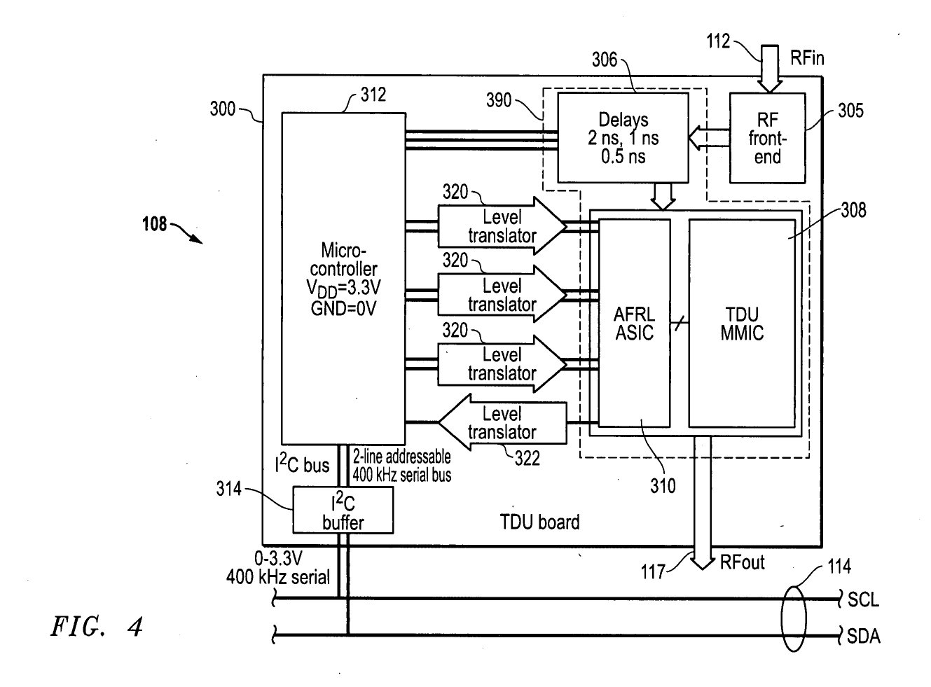

FIG. 4 illustrates an individual modular TDU 108 as it may be configured in a circuit board configuration according to one exemplary embodiment of the disclosed systems and methods using a 2-line addressable 400 kHz serial bus, although any other suitable control bus may be employed. As shown, TDU 108 is coupled to receive an incoming RF signal 112 at RF front end 305 (e.g., which may include one or more of components such as matching circuits, filters, amplifiers, limiters, etc.), which then provides the received RF signal to controllable time delay and amplitude circuitry 390.

In the exemplary embodiment of FIG. 4, controllable time delay and amplitude circuitry 390 includes phase delay circuitry 306 (e.g., 2, 1 and 0.5 nanoseconds, or any other combination of delay values suitable for a given application) which receives control signals from TDU controller circuitry 312 to control the amount of phase delay applied to the incoming received RF signal 112 that is then output to amplitude tapering circuitry 308 (e.g., implemented in this exemplary embodiment by time delay unit monolithic microwave integrated circuit (TDU MMIC)), where further phase delay and amplitude tapering necessary for forming and steering a desired narrow beam is performed to produce delayed RF signal 117. In this embodiment, phase delay circuitry 306 may be any circuitry suitable for selectively delaying the phase of an RF signal in response to a control signal from TDU controller circuitry 312, for example, a phase shifting device with multiple delay element devices such as described in U.S. Pat. No. 7,205,937 which is incorporated herein by reference in its entirety. Such delay element devices may incorporate switch devices (e.g., such as switch devices available from Hittite Microwave Corporation of Chelmsford, Mass.) that may be selectively controlled to vary circuit path and phase delay of the RF signal. Amplitude tapering circuitry 308 may be any circuitry suitable for selectively varying the amplitude of an RF signal in response to an amplitude control signal from TDU controller circuitry 312, e.g., such as MMIC circuit available from Cobham Sensor Systems in Richardson, Tex.

In the embodiment of FIG. 4, TDU controller circuitry 312 may be, for example, a microcontroller such as a dsPIC30F3012 peripheral interface controller (PIC) available from Microchip Technology of Chandler, Ariz. or other processing device (e.g., microprocessor, processor, field programmable gate array, application specific integrated circuit, etc.) that is suitable for controlling circuit components of controllable time delay and amplitude circuitry 390 based on phase delay and amplitude control signals received from master controller 102 across I²C control bus 114 via I²C buffer circuitry 314. Controllable time delay and amplitude circuitry 390 may also include Air Force Research Laboratory application-specific integrated circuit (AFRL ASIC) 310 that functions as an input translator that may be packaged in conjunction with TDU MMIC block 308 to perform the function of deserialization, to reduce the number of circuit-board control lines required to communicate between TDU controller circuitry 312 and TDU MMIC 308. As shown, voltage level translators 320 and 322 (e.g., Part No. LT1715CMS from Linear Technology of Milpitas, Calif.) may be provided if necessary to interface between TDU controller circuitry 312 and AFRL ASIC 310/TDU MMIC 308. TDU controller circuitry 312 may also include associated memory into which a lookup table that stores the mapping of beam position to delay and attenuation settings for respective phase delay circuitry 306 and amplitude tapering circuitry 308.

It will be understood that the particular circuit board configuration of TDU 108 illustrated and described in relation to FIG. 4 is exemplary only, and that any other combination of additional, fewer, or alternative circuit components may be employed that is suitable for performing one or more of the tasks described herein for TDU modules 108. However, by employing integrated circuit device components (such as TDU MMIC devices 308), each modular TDU 108 may be miniaturized to achieve space efficiency and save weight. Moreover, it will be understood that different TDU configurations are possible in other embodiments. For example, in an alternative exemplary embodiment,

RF front end 305 may not be present and incoming RF signal 112 may be instead received directly by amplitude tapering circuitry 308 which may have an output coupled to RF back end circuitry (output amplifier) with phase delay circuitry 306 coupled therebetween.

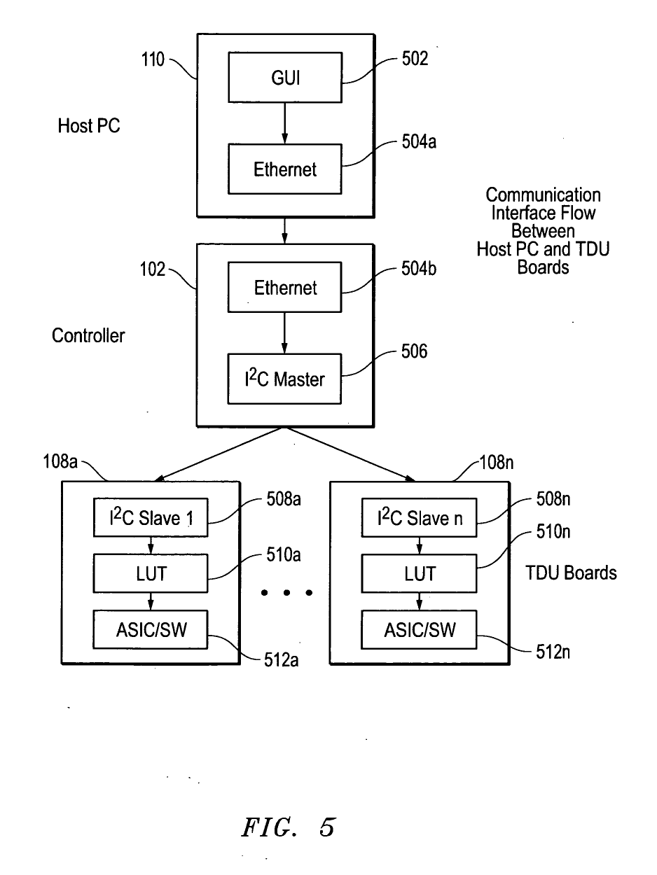

FIG. 5 shows one exemplary embodiment of logical control and communication interface flow between an external source 110 (e.g., in the form of a host laptop computer interface in the illustrated embodiment) and TDU modules 108a to 108n that may occur in response to a desired beam position input by a user via a graphical user interface (GUI) 502 of the external source 110 of FIG. 2. In this regard, a user may select beam positions (e.g., from a GUI menu presented by the computer interface) and the user selection transmitted (e.g., as unsigned char) from the external source 110 via Ethernet network 504 (e.g., direct connection from 504a to 504b) to the designated IP address of the master controller 102. In this embodiment, external source 110 communicates as a front-end interface from a user across an Ethernet network 504 to software-based master controller 102, although any other alternative communication medium (other than Ethernet) may be employed that is suitable for communicating user input desired beam position information between external source 110 and master controller 102.

Master controller 102 of FIG. 5 acts as an arbiter between host computer of external source 110 and each of TDU modules 108, by interpreting and translating the Ethernet commands into I²C commands for each of the addressable microcontrollers 312 of the TDU modules 108 corresponding to the beamformer elements. In this regard, master controller 102 communicates control signal data to the software-based TDU controller circuitry 312 of each TDU 108 (e.g., via I²C master component 506 of master controller 102 to I²C slave component 508 of each respective TDU 108a-108n), it being understood that any other signal bus suitable for individually controlling operation of each TDU 108 may be employed as previously described. In the embodiment of FIG. 5, a look up table (LUT) 510 and ASIC/software component 512 is also provided as shown for each TDU 108.

Still referring to FIG. 5, each TDU controller circuitry 312 receives the I²C command containing the user-chosen beam position from the master controller 312. The TDU controller circuitry 312 then sends the appropriate control message to TDU MMIC 308 or switch devices of phase delay circuitry 306 of the controllable time delay and amplitude circuitry 390 based on the microcontroller address to steer the beam in the corresponding direction. In this regard, the microcontroller addresses may be chosen if desired to correspond to the sequential location in the array for purpose of clarity and convenience. It will be understood that similar control signal methodology may be employed to control any other type of suitable delay circuitry that may be implemented within a controllable time delay and amplitude circuitry component 390 to selectively delay a signal for beamforming purposes.

While the invention may be adaptable to various modifications and alternative forms, specific embodiments have been shown by way of example and described herein. However, it should be understood that the invention is not intended to be limited to the particular forms disclosed. Rather, the invention is to cover all modifications, equivalents, and alternatives falling within the spirit and scope of the invention as defined by the appended claims. Moreover, the different aspects of the disclosed systems and methods may be utilized in various combinations and/or independently. Thus the invention is not limited to only those combinations shown herein, but rather may include other combinations.

What is claimed is:

1. A scalable analog beamforming system, comprising:
a plurality of time delay unit (TDU) modules, each of the TDU modules comprising TDU controller circuitry and each given one of the TDU modules being configured for coupling to at least one different array element of a phased array apparatus to receive and change at least one of the phase, amplitude, or combination of phase and amplitude of a signal received from or transmitted to the array element by the given TDU module under the control of the TDU controller circuitry; and
master control circuitry coupled to control the TDU controller circuitry of each of the TDU modules, the master control circuitry being configured to digitally control the TDU controller circuitry of each of the TDU modules to change the phase of a signal received from or transmitted to the array element.

2. The beamforming system of claim 1, wherein the master control circuitry is coupled by a control bus to control the TDU controller circuitry of each of the TDU modules.

3. The beamforming system of claim 2, wherein the number of TDU modules coupled to the control bus and controlled by the master control circuitry is arbitrarily variable in a scalable manner to fit a plurality of different phased array apparatus configurations, each different phased array apparatus configuration having a different number of array elements.

4. The beamforming system of claim 2, wherein the control bus is implemented by an addressable serial bus protocol.

5. The beamforming system of claim 2, wherein additional TDU modules may be added to the beamforming system by manipulation of a clamp-on connector to attach additional TDU modules to the control bus; and wherein existing TDU modules may be removed from the beamforming system by manipulation of a clamp-on connector to detach the existing TDU modules from the control bus.

6. The beamforming system of claim 1, wherein the TDU controller of each given TDU module is configured to set time-delay and attenuation parameters of the given TDU module based on control signals received from the master control circuitry.

7. The beamforming system of claim 6, wherein each TDU module further comprises controllable time delay and amplitude circuitry coupled to the TDU controller; and wherein the TDU controller of each given TDU module is configured to control the amount of phase delay and amplitude tapering applied to the signal received from or transmitted to the array element relative to the phase and amplitude of signals transmitted or received by other array elements of the array so as to control the direction of maximum signal intensity transmitted or received by the phased array apparatus.

8. The beamforming system of claim 1, wherein the master control circuitry is configured to independently control the TDU controller circuitry of each of the TDU modules by transmitting real time control signals to directly change at least one of the delay or amplitude tapering applied to the signal received from or transmitted to the array element so as to achieve a desired reconfigured beamformer configuration, the real time control signals containing at least one of a delay setting value or an amplitude taper setting value.

9. The beamforming system of claim 1, wherein each given TDU module comprises memory that contains beamformer system configuration information contained in a look-up table stored thereon, the beamformer system configuration information including at least one of delay setting values or amplitude setting values for the given TDU module corresponding to different beam positions; wherein the master control circuitry is configured to control the TDU controller circuitry of each of the TDU modules by transmitting a beam position command to all TDU modules that causes each of the TDU modules to respond by looking up at least one of delay setting or amplitude setting for each given TDU module that corresponds to the transmitted beam position command; and wherein the master controller is configured to dynamically change in real time the beamformer system configuration information contained in the memory of each TDU module by transmitting commands to each TDU module.

10. The beamforming system of claim 1, wherein each given TDU module comprises first integrated circuit memory that contains first beamformer system configuration information contained in a first look-up table stored thereon, the first integrated circuit memory being a part of a replaceable chip coupled to the TDU module by a removable interconnect system, and the first beamformer system configuration information including at least one of delay setting values or amplitude setting values for the given TDU module corresponding to different beam positions; wherein the master control circuitry is configured to control the TDU controller circuitry of each of the TDU modules by transmitting a beam position command to all TDU modules that causes each of the TDU modules to respond by looking up at least one of delay setting or amplitude setting for each given TDU module that corresponds to the transmitted beam position command; and wherein the first beamformer system configuration information is reconfigurable to second and different beamformer system configuration information by replacing the first integrated circuit memory on each TDU module with second integrated circuit memory that contains the second and different beamformer system configuration information contained in a second look-up table stored thereon.

11. The beamforming system of claim 1, wherein the master control circuitry is configured for coupling to receive user-input desired beam position information from an external source; and for communicating control signal data to the TDU controller circuitry of each of the given TDU modules to change the phase of a signal received from or transmitted to the array element of the given TDU module to achieve the user-input desired beam position.

12. A method for operating an analog beamforming system, comprising:
providing a plurality of time delay unit (TDU) modules of a beamforming system, each of the TDU modules comprising TDU controller circuitry and each given one of the TDU modules being coupled to at least one different array element of a phased array apparatus; and
digitally controlling the TDU controller circuitry of each given one of the TDU modules to change at least one of the phase, amplitude, or combination of phase and amplitude of a signal received from or transmitted to the array element by the given TDU module.

13. The method of claim 12, further comprising digitally controlling the TDU controller circuitry of each given one of the TDU modules from at least one off-module source to change at least one of the phase, amplitude, or combination of phase and amplitude of a signal received from or transmitted to the array element by the given TDU module.

14. The method of claim 12, further comprising providing a control bus to couple a common control source to each of two or more of the plurality of TDU modules for control; and manipulating a respective clamp-on connector to add each additional TDU module to the beamforming system by attaching the additional TDU module to the control bus, manipulating a respective clamp-on connector to remove each existing TDU module from the beamforming system by detaching the existing TDU module from the control bus, or a combination thereof.

15. The method of claim 12, further comprising varying the number of TDU modules controlled in a scalable manner to fit a plurality of different phased array apparatus configurations, each different phased array apparatus configuration having a different number of array elements.

16. The method of claim 12, further comprising providing a control signal to the TDU controller of each given TDU module to cause the TDU controller to set time-delay and attenuation parameters of the given TDU module.

17. The method of claim 16, further comprising using the TDU controller of each given TDU module to control the amount of phase delay and amplitude tapering applied to the signal received from or transmitted to the array element relative to the phase and amplitude of signals transmitted or received by other array elements of the array so as to control the direction of maximum signal intensity transmitted or received by the phased array apparatus.

18. The method of claim 12, further comprising independently controlling the TDU controller circuitry of each of the TDU modules by transmitting real time control signals from to directly change at least one of the delay or amplitude tapering applied to the signal received from or transmitted to the array element so as to achieve a desired reconfigured beamformer configuration, the real time control signals containing at least one of a delay setting value or an amplitude taper setting value.

19. The method of claim 12, wherein each given TDU module comprises memory that contains beamformer system configuration information contained in a look-up table stored thereon, the beamformer system configuration information including at least one of delay setting values or amplitude setting values for the given TDU module corresponding to different beam positions; and wherein the method further comprises:
controlling the TDU controller circuitry of each of the TDU modules by transmitting a beam position command to all TDU modules that causes each of the TDU modules to respond by looking up at least one of delay setting or amplitude setting for each given TDU module that corresponds to the transmitted beam position command; and
dynamically changing in real time the beamformer system configuration information contained in the memory of each TDU module by transmitting commands to each TDU module.

20. The method of claim 12, wherein each given TDU module comprises first integrated circuit memory that contains first beamformer system configuration information contained in a first look-up table stored thereon, the first integrated circuit memory being a part of a replaceable chip coupled to the TDU module by a removable interconnect system, and the first beamformer system configuration information including at least one of delay setting values or amplitude setting values for the given TDU module corresponding to different beam positions; and wherein the method further comprises:
controlling the TDU controller circuitry of each of the TDU modules by transmitting a beam position command to all TDU modules that causes each of the TDU modules to respond by looking up at least one of delay setting or amplitude setting for each given TDU module that corresponds to the transmitted beam position command; and
reconfiguring the first beamformer system configuration information to second and different beamformer system configuration information by replacing the first integrated circuit memory on each TDU module with second integrated circuit memory that contains the second and different beamformer system configuration information contained in a second look-up table stored thereon.

21. The method of claim 12, further comprising receiving user-input desired beam position information from an external source; and communicating control signal data from to the TDU controller circuitry of each of the given TDU modules to change the phase of a signal received from or transmitted to the array element of the given TDU module to achieve the user-input desired beam position.

22. A phased array apparatus, comprising:
a plurality of array elements;
a plurality of time delay unit (TDU) modules, each of the TDU modules comprising TDU controller circuitry and each given one of the TDU modules being coupled to at least one different array element to receive and change the phase of a signal received from or transmitted to the array element by the given TDU module under the control of the TDU controller circuitry; and
master control circuitry coupled to the TDU controller circuitry of each of the TDU modules, the master control circuitry being configured to digitally control the TDU controller circuitry of each of the TDU modules to change the phase of a signal received from or transmitted to the array element.

23. The phased array apparatus of claim 22, wherein the master control circuitry is coupled by a control bus to control the TDU controller circuitry of each of the TDU modules.

24. The phased array apparatus of claim 22, wherein each of the array elements comprises an antenna element; wherein the phased array apparatus comprises a radio frequency antenna; and wherein the received or transmitted signal is a radio frequency (RF) signal.

25. The phased array apparatus of claim 24, wherein the TDU controller of each given TDU module is configured to set time-delay and attenuation parameters of the given TDU module based on control signals received from the master control circuitry; wherein each TDU module further comprises controllable time delay and amplitude circuitry coupled to the TDU controller; and wherein the TDU controller of each given TDU module is configured to control the amount of phase delay and amplitude tapering applied to the signal received from or transmitted to the array element relative to the phase and amplitude of signals transmitted or received by other array elements of the array so as to control the direction of maximum signal intensity transmitted or received by the phased array apparatus.

26. The phased array apparatus of claim 24, wherein the master control circuitry is configured to independently control the TDU controller circuitry of each of the TDU modules by transmitting real time control signals to directly change at least one of the delay or amplitude tapering applied to the signal received from or transmitted to the array element so as to achieve a desired reconfigured beamformer configuration, the real time control signals containing at least one of a delay setting value or an amplitude taper setting value.

27. The phased array apparatus of claim 24, wherein each given TDU module comprises memory that contains beamformer system configuration information contained in a look-up table stored thereon, the beamformer system configuration information including at least one of delay setting values or amplitude setting values for the given TDU module corresponding to different beam positions; wherein the master control circuitry is configured to control the TDU controller circuitry of each of the TDU modules by transmitting a beam position command to all TDU modules that causes each of the TDU modules to respond by looking up at least one of delay setting or amplitude setting for each given TDU module that corresponds to the transmitted beam position command; and wherein the master controller is configured to dynamically change in real time the beamformer system configuration information contained in the memory of each TDU module by transmitting commands to each TDU module.

28. The phased array apparatus of claim 24, wherein each given TDU module comprises first integrated circuit memory that contains first beamformer system configuration information contained in a first look-up table stored thereon, the first integrated circuit memory being a part of a replaceable chip coupled to the TDU module by a removable interconnect system, and the first beamformer system configuration information including at least one of delay setting values or amplitude setting values for the given TDU module corresponding to different beam positions; wherein the master control circuitry is configured to control the TDU controller circuitry of each of the TDU modules by transmitting a beam position command to all TDU modules that causes each of the TDU modules to respond by looking up at least one of delay setting or amplitude setting for each given TDU module that corresponds to the transmitted beam position command; and wherein the first beamformer system configuration information is reconfigurable to second and different beamformer system configuration information by replacing the first integrated circuit memory on each TDU module with second integrated circuit memory that contains the second and different beamformer system configuration information contained in a second look-up table stored thereon.

29. The phased array apparatus of claim 24, wherein the master control circuitry is configured for coupling to receive user-input desired beam position information from an external source; and for communicating control signal data to the TDU controller circuitry of each of the given TDU modules to change the phase of a signal received from or transmitted to the array element of the given TDU module to achieve the user-input desired beam position.
